(19) United States
(12) Patent Application Publication
(10) Pub. No.: US 2022/0371417 A1
(43) Pub. Date: Nov. 24, 2022

(54) Telescoping Vehicle Cover

(71) Applicant: Michael Bani, Beverly Hills, CA (US)

(72) Inventor: Michael Bani, Beverly Hills, CA (US)

(21) Appl. No.: 17/326,124

(22) Filed: May 20, 2021

(51) Int. Cl. B60J 11/04

(52) U.S. Cl. CPC B60J 11/04

(57) ABSTRACT

The telescoping vehicle cover provides easy installation, secure coverage, and an easy removal as well as compression. A telescoping mechanism is embedded in the lining of the cover's width for going under the front and rear bumpers providing stability. The telescoping mechanism offers greater strength in secure coverage preventing winds blowing off the cover. It also allows the cover to be extended and collapsed. When the telescoping mechanism is extended, the cover is expanded, allowing for control in maneuvering the cover for installation, a snug secure fit, and for easy removal. When the cover is removed and the telescoping mechanism is collapsed, the corners of the cover come closer together. This allows for a more compressed and compact cover, ideal for storage.

### BACKGROUND OF THE INVENTION

The typical vehicle cover, whether it be for a sedan, convertible, truck, or van consists of a weather proof fabric for protection from environmental factors with an elastic hem—in order to keep the cover in place. However, the elastic hem system alone is not very efficient and at times tedious to use during installation and when folding for storage. The elastic hem is vulnerable to winds and does not allow for a secure snug fit, gusts of wind still blow off and lift covers out of place. Furthermore, the elastic hem does not provide enough control while maneuvering the cover during installation nor for compacting for storage. In most cases, the folding of the covers for storage is the most frustrating as it gets messy and very difficult to restore in the original storage bag it came with. The present invention provides solutions to easier installation, solutions to prevent vehicle covers from blowing off and making it easier to remove as well as compacting the cover for easy folding and storage.

### BRIEF SUMMARY OF THE INVENTION

The telescoping vehicle cover is the answer to easier installation, holding down the cover from winds, and to provide both easy removal and compacting for storage. The telescoping mechanism will be used for the lining in the widths of the vehicle cover. When both ends of the telescoping cover are extended and the vehicle is covered, the telescoping mechanism would be placed securely under both the front and rear bumpers—holding it in place and preventing any winds from lifting the cover. The telescoping system embedded in the cover system offers both expanding and collapsing features which allows for the ease in installation, the secure snug fit, and compacting for storage. When expanded, it is easy to determine the corners of the cover and it allows for better control while installing the cover. And when it is time to remove the cover, the telescoping mechanism allows for easy removal of the cover and is collapsable making the cover neatly compacted and easily foldable, ideal for storage.

### DETAILED DESCRIPTION

The telescoping vehicle cover, does in fact that. Telescoping refers to concentric tubular parts which slides out and slides inside itself, so that it becomes longer or shorter. The presented invention features a telescoping mechanism embedded into the front and rear end widths of the vehicle cover along with the elastic hem at the bottom of the cover. This allows for the cover to expand and condense uniformly with control and stability. When installing the cover, the ends of the cover will have to be extended. The extended length will be sufficient accordingly to the width of the particular vehicle. Once the cover's width is fully expanded, the length of the cover is freely maneuverable and whether to start covering the vehicle from the front or rear end the telescoping mechanism at the widths provides the needed maneuvering control. Once the vehicle is fully covered and draped, the telescoping mechanism built into the front and rear end widths of the vehicle cover will be placed underneath both the front and rear bumpers. The now extended telescoping mechanism provides structural support for a snug fit, which disables gusts of winds from penetrating between the cover and vehicle and blowing off the cover. When removing the telescoping vehicle cover, the extended telescoping mechanism continues to provide the needed maneuvering control needed while removing the cover from under either the front or rear bumper of the vehicle. When the cover is completely removed off the vehicle, the telescoping mechanism can now be condensed from its width and shortened, ready for easy folding and storage. The telescoping vehicle cover is now in a narrow state with distinguished ends, ready to be folded and compressed for storage.

### DRAWING DESCRIPTIONS

### Brief Description of the Drawings

The presented invention is illustrated in different perspectives supporting the features of the telescoping vehicle cover. The following illustrations displays the functions and claims of the telescoping vehicle cover specifically for a sedan car.

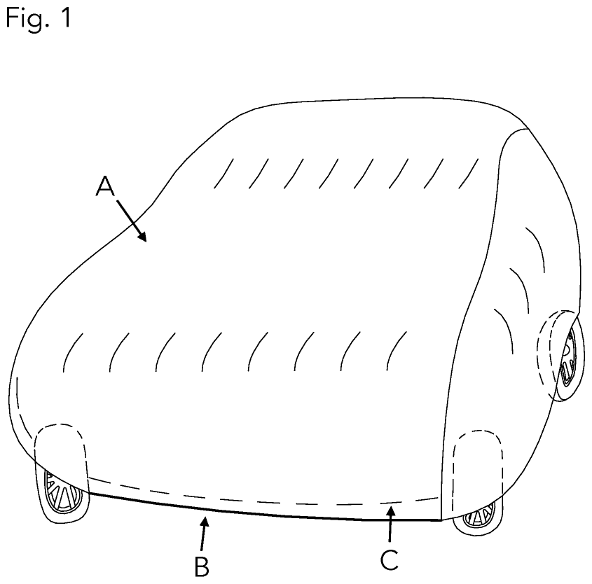

FIG. 1 is the front angle of the telescoping vehicle cover when expanded and installed showing both the front and side of the covered sedan. The front and back angle would essentially look the same.

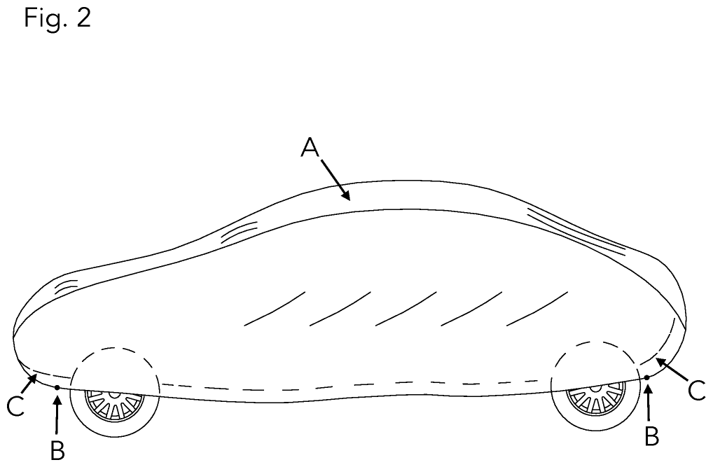

FIG. 2 is the side angle, profile of the covered sedan illustrating the telescoping vehicle cover when expanded and installed.

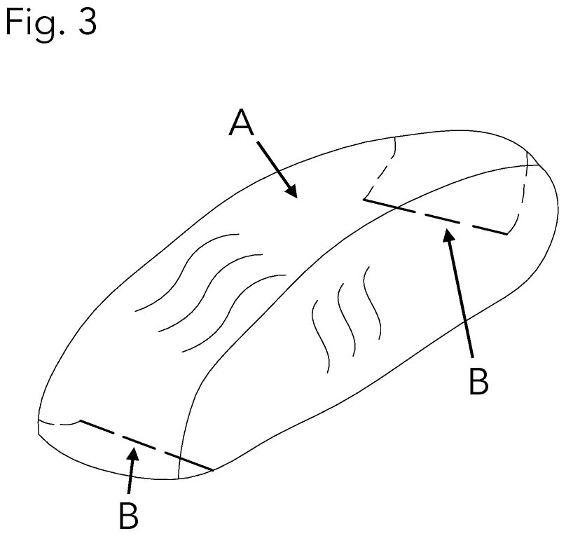

FIG. 3 shows both the front and side of the telescoping vehicle cover when it is removed and collapsed.

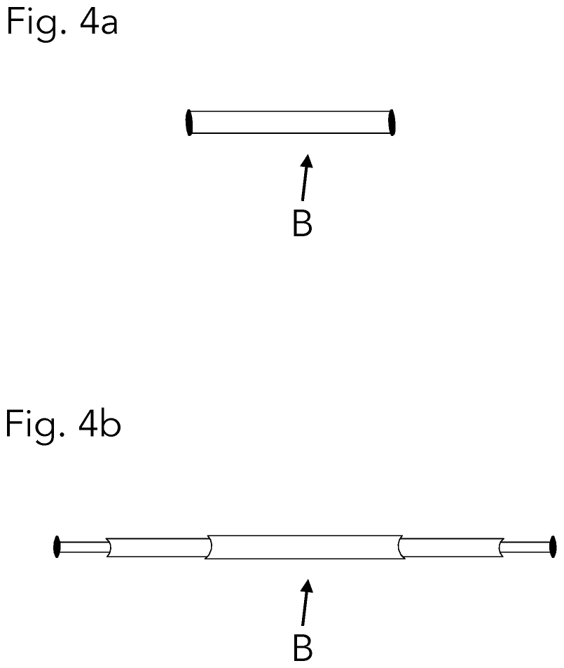

In FIG. 4a it shows the telescoping mechanism itself when collapsed and in FIG. 4b it is the same telescoping mechanism in FIG. 4a when expanded.

### DETAILED DESCRIPTION OF THE DRAWINGS

In more detail, the illustrations provide better understanding of the functions and claims of the presented invention. In FIG. 1 it shows the front angle of the telescoping vehicle cover (A) when expanded and installed. The telescoping mechanism (B) is embedded in the elastic hem lining which is shown secure under the bumper. When installing the cover, it provides control over the entire width—the lining end of the vehicle cover where the telescoping mechanism is embedded. Once under the vehicle bumpers (C), as shown in FIG. 2 either the front or the rear, the telescoping mechanism (B) will hold against underneath the bumpers with the help of the elasticity of the lining. When removing the telescoping vehicle cover (A), starting from either bumper, the telescoping mechanism is easy to locate and to pull out from underneath, just like when installing there is great control when then uncovering the vehicle. In FIG. 3 the cover is completely removed off of the sedan and showing both front and side angles of the collapsed telescoping vehicle cover (A). The widths of the telescoping vehicle cover where the telescoping mechanism (B) in the lining is can now condensed and come closer together. Now that the cover is off the vehicle, all ends of the cover come closer together since it is no longer outstretched by the vehicle. The telescoping vehicle cover is ready to be folded and compacted for storage. In FIG. 4a it is a closeup of the telescoping mechanism (B) which is embedded in the lining of the telescoping vehicle cover in its collapsed and condensed form. FIG. 4b is the closeup of the same telescoping mechanism (B) which is embedded in the lining of the telescoping vehicle cover in its extended form.

What is claimed:

1. A vehicle cover allowing for easy installation, secure coverage of vehicle, easy removal and compression.

2. A vehicle cover according to claim 1, wherein a telescoping mechanism embedded in the cover lining is used for easy maneuvering control when expanded for installation and removal.

3. A vehicle cover according to claim 1, wherein a telescoping mechanism embedded in the cover lining is used for structural support under the front and rear bumpers of a vehicle when installed in order to have a secure and snug fit.

4. A vehicle cover according to claim 1, wherein a telescoping mechanism embedded in the cover lining allows for the cover to collapse and have its corners come closer together to be in a more compressed and compact state.
